(19) United States
(12) Patent Application Publication
(10) Pub. No.: US 2026/0027549 A1
(43) Pub. Date: Jan. 29, 2026

(54) MOISTURE ABSORBENT FILMS AND FACE MASKS INCORPORATING THE FILMS

(71) Applicant: Kimberly-Clark Workwide, Inc., Neenah, WI (US)

(72) Inventors: Peiguang Zhou, Suwanee, GA (US); Kaiyuan Yang, Cumming, GA (US); Wing-Chak Ng, Roswell, GA (US); Xyedong Song, Alpharetta, GA (US); Richmond R. Cohen, Appleton, WI (US); Uyen T. Lam, Menasha, WI (US)

(73) Assignee: Kimberly-Clark Workwide, Inc., Neenah, WI (US)

(21) Appl. No.: 18/998,758

(22) PCT Filed: Jul. 13, 2023
(86) PCT No.: PCT/US2023/027680

§ 371 Date: Jan. 27, 2025

Related U.S. Application Data
(60) Provisional application No. 63/400,649, filed on Aug. 24, 2022.

(51) Int. Cl. B01J 20/28; A41D 13/11; B01J 20/26

(52) U.S. Cl. CPC B01J 20/28026; A41D 13/11; B01J 20/26; B01J 20/28004; B01J 20/28045

(57) ABSTRACT

The present disclosure relates to moisture absorbent materials, including films and foams, formed from a substantially homogeneous blend of a water-soluble/swellable polymer and an aromatic thermoplastic polyurethane. The materials also include fine particles of a superabsorbent material. The materials expand when contacted by moisture but retract when they dry. The films can be used in combination with protective face masks to capture the moisture from breath exhaled by a person wearing the mask before the moisture can leave the mask, so the moisture causes substantially less condensation and fog on surfaces adjacent to the mask, such as eyeglasses.

### CROSS-REFERENCE TO RELATED APPLICATION

This application claims the benefit of and priority to U.S. Provisional Patent Application No. 63/400,649, filed Aug. 24, 2022, which is hereby incorporated by reference in its entirety for all intents and purposes.

### FIELD

The present disclosure generally relates to absorbable materials and articles that include absorbable materials. In particular, the present disclosure relates to a polymer blend that includes a superabsorbent material.

### BACKGROUND

Personal protective equipment, including face masks, are essential not only in research or hospital environments, but also by individuals looking to protect their health. For instance, face masks worn by individuals in public places may protect the wearer from inhaling airborne particulates including dust, bacteria, harmful organisms or other contaminants in the environment. Face masks also provide individuals in proximity to the wearer with protection against respiratory droplets that are expelled with the wearer's breath or when the wearer talks, coughs, or sneezes.

An essential aspect of a face mask is to filter the breathable air in an environment. This may require that the face mask provides a snug fit to the wearers face. In most instances this may dictate that the facemask be in immediate contact with the area of the wearer's face surrounding the mouth and nose. Most facemasks, however, do not form an airtight seal, so at least some air gets in and out around the edges. In the event that a face mask wearer also wears eye protection or corrective glasses, breath that escapes from the mask upward toward the eyes may fog the eyewear, due to the moisture in the breath. The eye-glass fogging may be exacerbated when the wearer is performing moderate or intense physical activity such as walking, running, and in some cases speaking. Excessive fogging of eyewear while wearing a mask can be a safety concern as continuous fogging of the eyeglass leads to poor vision and interrupts the actions of the wearer to correct the fogging.

Manufacturers have been attempting to resolve eyeglass fogging by incorporating additional components to the facemask such as adhesives along the nose bridge portion of the mask to seal the gap between the nose and the mask. Due to high humidity in exhaled air, adhesives along the bridge do not prevent eye-glass fogging.

Thus, there is a need for face masks and/or materials for use in the face masks that prevent moisture from escaping the masks and fogging eyeglasses. There is further need, or desire, for a material with good absorbency performance and reusability.

### SUMMARY

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

In some embodiments, the present disclosure provides an absorbent material comprising a water-soluble polymer, a thermoplastic polyurethane (TPU), and a superabsorbent material. In some embodiments, the TPU comprises aromatic groups and ester groups. In some embodiments, the water-soluble polymer comprises polyethylene oxide (PEO) comprising a weight average molecular weight (MW) greater than 50,000. In some embodiments, the superabsorbent material has an average particle diameter from 10 microns to 100 microns.

In alternative embodiments, the present disclosure provides an article comprising: an absorbent material comprising: a thermoplastic elastomer; a polyethylene oxide (PEO) comprising a weight average molecular weight (Mw) greater than 50,000; and a superabsorbent material. In some embodiments, the thermoplastic elastomer is a thermoplastic polyurethane (TPU). In some embodiments, the TPU comprises aromatic groups and ester groups. In some embodiments, the TPU comprises aromatic isocyanate monomers and polyester polyol monomers. In some embodiments, the PEO comprises a Mw greater than 150,000. In some embodiments, the absorbent material is a film. In some embodiments, the absorbent material is a foam. In some embodiments, the absorbent material comprises a film or foam non-woven laminate. In some embodiments, the absorbent article is a face mask. In some embodiments, the absorbent material is a user-facing external layer of the face mask, and wherein the absorbent material is configured to directly or indirectly contact a user's skin. In some embodiments, the superabsorbent material has a particle diameter of between 10 and 400 microns. In some embodiments, the film has a thickness of less than 500 micron. In some embodiments, the absorbent material exhibits an increase in absorbent capacity as measured by a dynamic vapor sorption test of at least 100%. In some embodiments, the article further comprises a polyolefin-based adhesive for securing the absorbent material to the article.

Further aspects, objects, and advantages will become apparent upon consideration of the detailed description.

### BRIEF DESCRIPTION OF THE FIGURES

FIGS. 1A-1C are schematic illustrations of the microstructure of an example composition of an absorbent material under expansion and contraction, according to some embodiments described herein.

FIG. 2 is a schematic of a system for producing an absorbent film, according to some embodiments described herein.

FIG. 3 is an illustration of a face mask comprising an absorbent material, according to some embodiments described herein.

FIG. 4 is a graph of the moisture intake speed of an example thin film composition at different relative humidity percent, according to some embodiments described herein.

FIG. 5 is a graph of the mass percent change of an example thin film composition at different relative humidity percent, according to some embodiments described herein.

FIG. 6 is a graph of the moisture intake speed of an example superabsorbent particle at different relative humidity percent, according to some embodiments described herein.

FIG. 7 is a graph of the mass percent change of an example superabsorbent particle at different relative humidity percent, according to some embodiments described herein.

FIG. 8 is a graph of the moisture intake speed of superabsorbent particles, according to some embodiments described herein.

### DETAILED DESCRIPTION

The present disclosure is generally directed to absorbent materials, such as films, for use in face masks and other articles. The absorbent materials and face masks are useful for capturing moisture vapor, which prevents the moisture vapor from condensing on a substrate in proximity with the face mask. For example, the face mask traps moisture vapor, such as from a user's breath, and prevents the moisture vapor from leaving the mask and condensing on an adjacent surface, such as but not limited to the user's eyeglasses. Each example herein is provided by way of explanation and is not meant as a limitation. For example, features illustrated or described as part of one embodiment or figure can be used on another embodiment or figure to yield yet another embodiment. It is intended that the present disclosure include such modifications and variations.

### Definitions and Descriptions

The terms “invention,” “the invention,” “this invention,” and “the present invention” used herein are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

The term “film” refers herein to a thermoplastic film made using an extrusion and/or forming process, such as a cast film or blown film extrusion process. The term includes apertured films, slit films, and other porous films which constitute liquid transfer films, as well as films which do not transfer fluids, such as, but not limited to, barrier films, filled films, breathable films, and oriented films.

The term “superabsorbent” refers herein to a water-swellable, water-insoluble organic or inorganic material capable, under the most favorable conditions, of absorbing at least about 15 times its weight and, in an embodiment, at least about 30 times its weight, in an aqueous solution containing 0.9 weight percent sodium chloride. The superabsorbent materials can be natural, synthetic, and modified natural polymers and materials. In addition, the superabsorbent materials can be inorganic materials, such as silica gels, or organic compounds, such as cross-linked polymers.

The term “thermoplastic” refers herein to a material which softens, and which can be shaped when exposed to heat and which substantially returns to a non-softened condition when cooled.

The terms “water-soluble” or “water-swellable” refer herein to a material that loses its integrity over time in the presence of water.

### Absorbent Material

In various embodiments, an absorbent material described herein is polymer composition in the form of a film or a foam. The film or foam can absorb and desorb moisture repeatedly. The polymer composition essentially is a blend of a water-soluble polymer and an elastomeric thermoplastic polyurethane (TPU), with fine superabsorbent particles dispersed throughout the blend. In some embodiments the polymer composition may include one or more additional components. The polymer composition described herein is in the form of a thin film or a foam, or the polymer composition can be used to produce a thin film or a foam. The polymer blend serves as a bridge to transfer moisture from the environment to the absorbent material to the superabsorbent particles, which capture and retain the moisture, thus removing it from the environment.

### Water-Soluble or Swellable Polymer (W-S)

Water-soluble (swellable) polymers useful in the absorbent material are not particularly limited but should form a substantially homogeneous blend with the TPU. Examples of useful water-soluble polymers include, but are not limited to, polyethylene oxides (PEO), polypropylene oxides (PPO), polybutylene oxides (PBO), polyvinyl alcohol (PVA), and polyethylene glycol (PEG), hydroxypropyl cellulose, polyvinyl pyrrolidone, polyvinyl pyridine, gelatinized starch, nylon copolymers, polyacrylic acid, and mixtures thereof.

A w-s polymer used in the absorbent material should allow moisture to come into the film. In some examples, the w-s polymer can have some crystallinity. In some examples, the w-s polymer can have a crystallinity of at least 40%, at least 50%, or at least 60%. The crystallinity of the w-s polymer should be high enough so that the film has a crystallinity of at least 25%. In some examples, the film has a crystallinity of at least 25%, at least 35%, or at least 45%.

Any absorbent material described herein can include one or more water-soluble polymers. In some examples, the w-s polymer has a weight average molecular weight (Mw) greater than 25,000, greater than 50,000, greater than 75,000, greater than 100,000, greater than 125,000, greater than 150,000, greater than 175,000, greater than 200,000, greater than 225000, or greater than 250,000. In some embodiments, the polymer composition includes the w-s polymer in an amount from about 10 wt. % to about 90 wt. %, based on the total weight of the composition (e.g., from 15 wt. % to 85 wt. %, from 20 wt. % to 80 wt. %, from 25 wt. % to 75 wt. %, from 30 wt. % to 70 wt. %, from 30 wt. % to 65 wt. %, from 30 wt. % to 70 wt. %, from 35 wt. % to 65 wt. %, or from 40 wt. % to 60 wt. %). In some embodiments, the composition includes at least 10 wt. % of water-soluble polymer (e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. %). In some examples, the w-s polymer is a PEO. In some examples, the PEO has a weight average molecular weight (Mw) greater than 25,000, greater than 50,000, greater than 75,000, greater than 100,000, greater than 125,000, greater than 150,000, greater than 175,000, greater than 200,000, greater than 225000, or greater than 250,000.

### Elastomeric Thermoplastic Polyurethane (TPU)

The TPUs useful in the absorbent materials described herein form substantially homogeneous blends with the w-s polymer. Generally, a thermoplastic polyurethane (“TPU”) is a block copolymer consisting of alternating hard (i.e., crystalline) and soft (i.e., amorphous) segments or domains. The soft segments provide flexibility and elasticity, and the hard segments provide strength.

Thermoplastic polyurethanes are generally synthesized from a diol (or polyol), organic diisocyanate, and optionally a chain extender. A polyol is generally any high molecular weight product having an active hydrogen component that may be reacted and includes materials having an average of about two or more hydroxyl groups per molecule. Typically, the polyol is substantially linear and has two to three hydroxyl groups, and a number average molecular weight of from 450 to 10,000, e.g., 450 to about 6000, or from 600 to 4500 D. Short-chain diols provide a harder, more crystalline polymer segment, and long-chain diols provide a softer, more amorphous polymer segment. The chemical structure of the diols also affects the polymer properties. For example, TPUs formed from polyether-based diols can have different properties than those formed from polyester-based diols. The isocyanate selected for the TPU also affects the properties of the polymer. For example, TPUs formed from aromatic isocyanates can have different properties than those formed from aliphatic isocyanates.

TPUs sometimes, but do not always, include a chain extender. Chain extenders typically have a number average molecular weight of from about 60 to 400 and include amino, thiol, carboxyl, and/or hydroxyl functional groups. Examples of chain extenders include, but are not limited to, ethanediol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. In some embodiments, the TPU can include a chain extender. In some embodiments, the chain extender includes two to three hydroxyl groups.

By varying the ratio of diol to diisocyanate as well as the structure and molecular weight of each monomer, different TPUs can be synthesized. A variety of TPUs were investigated for use in the absorbent materials described herein, including aromatic polyester-based polyurethanes (aromatic-ester TPUs), aromatic polyether-based polyurethanes (aromatic-ether TPUs), aliphatic polyester-based polyurethanes (aliphatic-ester TPUs), and aliphatic polyether-based polyurethanes (aliphatic-ether TPUs). Generally, the aromatic or aliphatic segments of the TPU were derived from an aromatic or aliphatic isocyanate monomer, and the polyester or polyether segments of the TPU were derived from a polyester or polyether polyol monomer.

Films formed from blends of w-s polymers with aromatic-ester TPUs have properties superior to those of films formed from blends of w-s polymers with aromatic-ether, aliphatic-ether, or aliphatic-ester TPUs. In the absorbent materials described herein, useful aromatic-ester TPUs include, but are not limited to, TPUs where polyester segments are derived from a polyester diol and an aromatic isocyanate. Examples of the polyester diol include but are not limited to ethanediol polyadipates; 1,4-butanediol polyadipates; ethanediol-1,4-butanediol polyadipates; 1,6-hexanedianeopentyl glycol polyadipates; 1,6-hexanediol/1,4-butanediol polyadipates; polycaproplactones; and mixtures thereof. Examples of the aromatic diisocyanate include but are not limited to 2,4-or 2,6-toluene diisocyanate; 4,4′-diphenylmethane diisocyanate; 2,4′-diphenylmethane diisocyanate; 2,2′-diphenylmethane diisocyanate; naphthylene-1,5-diisocyanate; xylylene diisocyanate; methylene diphenyl isocyanate (“MDI”); hexamethylene diisocyanate (“HMDI”); and mixtures thereof.

Any absorbent material described herein can include one or more TPUs. In some embodiments, the TPU has a melting point of from 75° C. to 250° C., for example, from 100° C. to 240° C. or from 120° C. to 220° C. The glass transition temperature (“T_{g}”) of the thermoplastic polyurethane can be relatively low, for example, from −150° C. to 0° C., e.g., from −100° C. to −10° C., from −85° C. to −20° C., or from −60° C. to −25° C. The melting temperature and glass transition temperature may be determined using differential scanning calorimetry (“DSC”) in accordance with ASTM D-3417. In some examples, the composition described herein includes TPU in an amount of from 10 wt. % to 90 wt. %, based on the total weight of the composition (e.g., from 15 wt. % to 85 wt. %, from 20 wt. % to 80 wt. %, from 25 wt. % to 75 wt. %, from 30 wt. % to 70 wt. %, from 30 wt. % to 65 wt. %, from 30 wt. % to 70 wt. %, from 35 wt. % to 65 wt. %, or from 40 wt. % to 60 wt. %). In some embodiments, the composition includes at least 10 wt. % TPU (e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %.

### Super-Absorbent Material (SAM)

The absorbent material further includes a superabsorbent material (SAM). Superabsorbent materials generally are employed to increase the absorbent capacity of a material. The SAMs are present in the absorbent material in the form of fine particles or powders. Any type of SAM can be used including natural, synthetic, and modified natural materials: inorganic materials (such as silica) or organic materials (such as chitin or starch); and biodegradable or non-biodegradable materials. Superabsorbent materials useful in the absorbent material described herein include polymeric powders, such as but not limited to, a wide variety of anionic, cationic, and nonionic polymer materials. Suitable polymers include polyacrylamides, polyvinyl alcohols, ethylene maleic anhydride copolymer, polyvinylethers, polyacrylic acids, polyvinylpyrrolidones, polyvinylmorpholines, polyamines, polyethyleneimines, polyquaternary ammoniums, natural based polysaccharide polymers such as carboxymethyl celluloses, carboxymethyl starches, hydroxypropyl celluloses, algins, alginates, carrageenans, acrylic grafted starches, acrylic grafted celluloses, chitin, chitosan, and synthetic polypeptides such as polyaspartic acid, polyglutamic acid, polyasparagins, polyglutamines, polylysines, and polyarginines, as well as the salts, copolymers, and mixtures of any of the foregoing polymers.

The superabsorbent particles in the absorbent materials described herein should have an average particle size from about 10 microns to about 300 microns. In some examples, the average particle size of the superabsorbent particles is from about 10 microns to about 50 microns (for example from about 10 to about 40 microns, from about 10 to about 30 microns, or from about 10 to about 20 microns). For example, in embodiments where the absorbent material is a thin film, the film may have a total thickness of about 100 microns. The superabsorbent particles must be smaller than the film thickness, and for uniform dispersion and good functionality, the particles should be significantly smaller than the film thickness. For example, for a film with a thickness of about 100 microns, the superabsorbent particles can have an average particle size of up to about 15 microns, up to about 20 microns, or up to about 25 microns. In embodiments where the film is thicker, or where the absorbent material is a foam, the average particle size of the superabsorbent material can be up to 50 microns, up to 100 microns, up to 200 microns, up to 300 microns, or up to 500 microns.

In some embodiments, the foam has a thickness greater than 300 microns (e.g., greater than 350 microns, greater than 400 microns, greater than 350 microns, greater than 500 microns, or greater than 550 microns).

In addition to the components noted above, one or more other additives may also be incorporated into the composition, such as a plasticizer (e.g., a sugar, sugar alcohol, polyol, urea, animal protein, ester, combinations thereof, and/or derivatives thereof), a starch or derivative thereof, slip additives (e.g., fatty acid salts, fatty acid amides, etc.), compatibilizers (e.g., functionalized polyolefins), dispersion aids, melt stabilizers, processing stabilizers, heat stabilizers, light stabilizers, antioxidants, heat aging stabilizers, whitening agents, antiblocking agents, bonding agents, lubricants, fillers, etc.

Optionally, the absorbent material can further include a surface treatment to form a coating on the outer-most surface of the material. The coating can provide beneficial properties while not impacting the absorption capacity of the film. For example, the surface coating can be an antimicrobial coating that provides an antimicrobial benefit to the user of the mask. A material is considered antimicrobial if it is capable of effectively killing microorganisms. Examples of antimicrobial coatings include, but are not limited to, TiO₂-containing coatings, SiO₂-containing coatings, aromatic compound-containing coatings, or other coatings that contribute to an antimicrobial effect.

In some examples, the absorbent material described herein is a film or foam where the blend of w-s polymer and TPU is a first layer, and the foam or film further includes one or more additional layers. For example, the additional layer can be an adhesive layer that is used to secure the film or foam to an external layer of a face mask or other article. Examples of suitable adhesive materials include hydrophobic and hydrophilic hot melt polymers, such as those available from Henkel. (having a place of business located in Bridgewater, New Jersey, U.S.A.) such as 34-5610, 34-447A, 70-3998 and 33-2058; those available from Bostik-Findley (having a place of business located in Milwaukee, Wisconsin, U.S.A.) such as HX 4207-01, HX 2773-01, H2525A, H2800, H9574; and those available from H.B. Fuller Adhesives (having a place of business located in Saint Paul, Minnesota, U.S.A.) such as HL8151-XZP. Examples of other suitable adhesive materials include polyolefin-based adhesives, which have low to non-tacky behavior, may be creep resistant, and may be non-toxic and recyclable.

The combination of water-soluble polymer and TPU disclosed herein provides advantageous results. For example, the combination forms a substantially homogeneous blend, which is important to the water absorption properties of the material. If the w-s polymer and the TPU separate into distinct layers, absorption will be slow or may not occur at all. For example, if the polymers separate, and the TPU is on the surface, the TPU could prevent moisture from reaching the superabsorbent particles, which would prevent beneficial levels of absorption and may prevent any absorption.

The blend of w-s polymer and TPU forms a matrix in which the SAM particles are dispersed. The SAM particles are substantially uniformly dispersed within the polymer matrix. Non-uniform dispersion of the SAM particles adversely affects the performance of the absorbent material. Without wishing to be bound by theory, it is believed that the hard segments of the TPU interact most strongly with the crystalline segments of the w-s polymer, while the soft segments of the TPU interact most strongly with the amorphous segments of the w-s polymer. The w-s polymer provides a means for the film to capture moisture vapor and for that moisture vapor to traverse the polymer blend to the superabsorbent material, where it is absorbed and retained.

During moisture capture and transfer to the SAM, the crystalline segments of the w-s polymer dissolve to some extent, causing the crystalline segments to convert to a more amorphous structure. The physical interactions with the hard segments of the TPU, however, stabilize the w-s polymer, preventing it from completely dissolving as the moisture is transferred through the film to the SAM. Nevertheless, sufficient change in morphology of the crystalline regions causes the bulk absorbent material to expand. The extent of expansion depends, among other things, on the amount of moisture absorbed and the absorbent capacity of the SAM.

The absorption and expansion are reversible and repeatable. If the wet absorbent material is placed in a dry environment, water will desorb. Sufficient water desorption will cause the material to contract to the original state, after which it can absorb water again.

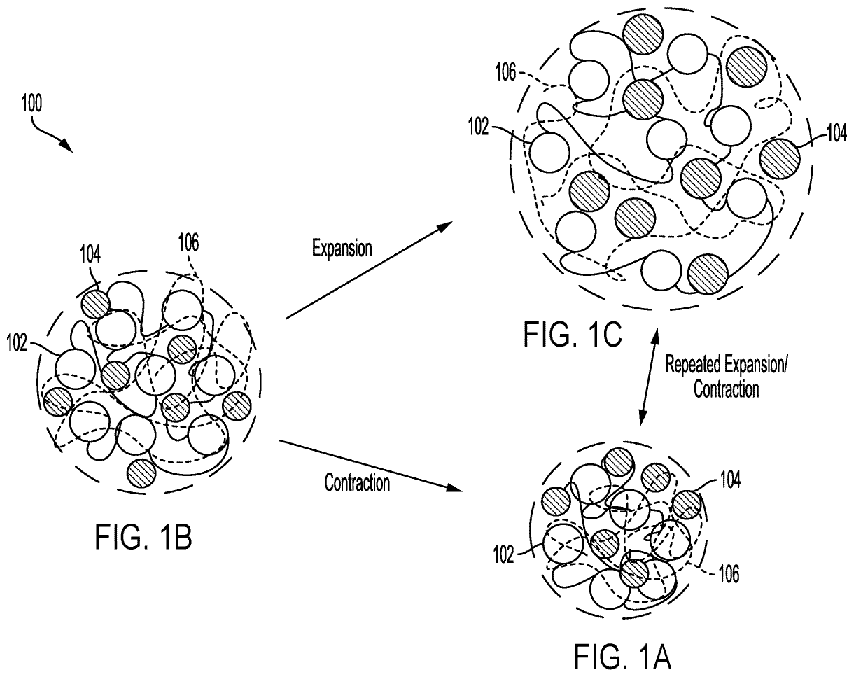

FIGS. 1A-1C are schematic illustrations of the microstructure of a polymer composition in one example of an absorbent material 100, as described herein. The polymer composition is depicted under three stages of expansion/contraction, shown in panels A, B, and C. In FIG. 1, the absorbent material 100 includes a water-soluble polymer 102, a TPU 106, and a SAM 104. In FIG. 1, panel A shows a dry material, panel B shows the same material expanded after some water absorption, and panel C shows the same material after additional water absorption. The reverse desorption process is also depicted.

In some examples, with three minutes of immersion in an aqueous liquid, the absorbent material described herein can expand up to a 100% increase in surface area, up to a 150% increase in surface area, or up to a 250% increase in surface area.

When the absorbent material is a film, in some embodiments the film can have a thickness of from about 50 microns to about 400 microns (e.g., from about 50 microns to about 200 microns, from about 50 microns to about 100 microns, from about from about 70 microns to about 150 micron, or from about 90 microns to about 200 microns). In some embodiments, the film has a thickness less than 400 microns (e.g., less than 350 microns, less than 300 microns, less than 250 microns, less than 200 microns, or less than 150 microns). In some embodiments, the film can have a width of from about 5 mm to about 15 mm. In some embodiments, the film can have a length of from about 50 mm to about 150 mm. The film is flexible and can conform to an article with which it is used.

Any known technique may be used to form a film described herein, including blowing, casting, flat die extruding, etc. In some embodiments, the film can be formed by blending each of the components together using any of a variety of known techniques. For example, the components may be supplied to the blending device separately or in combination. The components can be dry mixed together to form an essentially homogeneous mixture of dry ingredients before melt processing. Alternatively, the components can be supplied either simultaneously or in sequence to a melt processing device (e.g., extruder) that uniformly blends the materials.

The film can be prepared by a batch or continuous processing technique. For example, a mixer/kneader, Banbury mixer, Farrel continuous mixer, single-screw extruder, twin-screw extruder, roll mill, etc., may be utilized to blend and melt process the materials. Examples of suitable melt processing devices include a co-rotating, twin-screw extruder (e.g., USALAB twin-screw extruder available from Thermo Electron Corporation of Stone, England, or an extruder available from Werner-Pfreiderer from Ramsey, N.J.). Such extruders can include feeding and venting ports and provide high intensity distributive and dispersive mixing. In any case, after extrusion, the composition should be homogeneous.

The film composition described herein can be prepared by combining a water-soluble polymer with a TPU and SAM particles, blending until the mixture is homogeneous, and extruding the mixture through a film die. In some examples, the TPU is provided as pellets and the w-s polymer is a dry powder. Optionally, the ratio of TPU to w-s polymer is from about 1:2 to about 2:1. In some examples the ratio of TPU to w-s polymer is about 1:1. In some examples the polymer blend is extruded with a twin-screw extruder having a temperature profile from about 200° F. to about 450° F. (e.g., from about 300° F. to about 350° F., or from about 300° F. to about 400° F. In some examples, the polymer composition is heated to at least 100° F., at least 125° F., at least 150° F., at least 170° F., at least 180° F., or at least 190° F.).

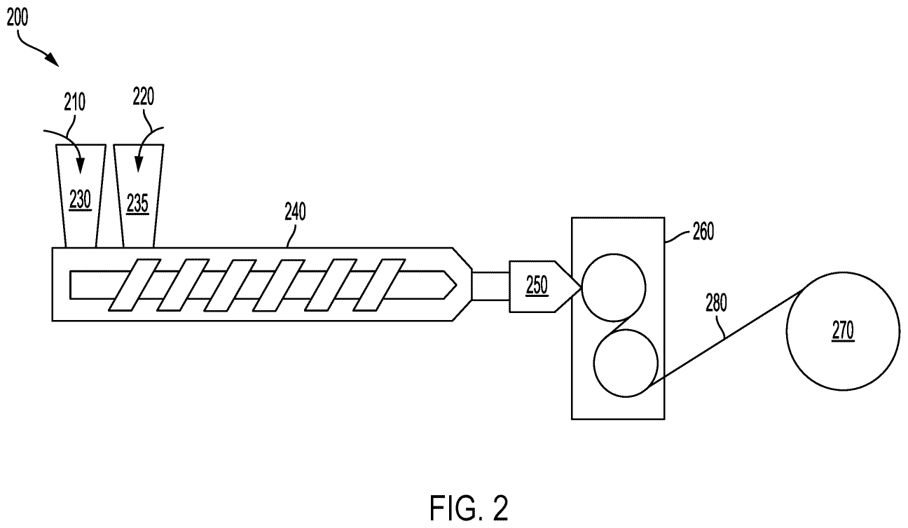

FIG. 2 illustrates one exemplary system for producing a film according to some embodiments of the invention. The raw materials (e.g., water-soluble polymer, TPU, superabsorbent polymer, optional additives, etc.) are supplied to a melt blending device, either separately or as a blend. An extruder may be employed that includes one or more feeding and venting ports. The system 200 of FIG. 2 has two feeding ports 230, 235 for adding the water-soluble polymer 210 and the TPU 220. Alternatively, however, the polymers could be added simultaneously or sequentially using the same port or different ports. The system 200 uses a single-screw extruder 240. Alternatively, however, the system could use any appropriate extruder, such as a double-screw extruder. The polymer melt from the extruder 240 can be processed through the film die 250 to produce the film 280. As shown in FIG. 2, the system 200 includes chill rollers 260 and a roller 270 to draw and collect the extruded film 280 downstream of the film die. Alternatively, however, the system could omit one or more of the rollers. In another example, the TPU, w-s polymer, and SAP are pre-compounded and formed into pellets. The pellets are then used for the film extrusion by either a single or twin-screw extruder.

Any known technique may be used to form a foam as described herein. In some examples, a water-soluble polymer, a TPU, and SAM particles are combined with solvent and a foaming agent, and mixed to blend the polymers and uniformly disperse the SAM particles. Any suitable foaming agent can be used, such as but not limited to sodium dodecyl sulfate (SDS) surfactant. This process creates a stable wet foam with high viscosity and consistency some describe as shaving cream-like. Optionally, the wet foam can be formed into any desired shape, such as a thin sheet. The wet foam is heated and dried to remove solvent.

### Articles Including the Absorbent Material

In various embodiments, an absorbent material described herein is combined with an article, such as an article of clothing or an article of protective gear. As one example, the absorbent material can be combined with a face mask. When combined with a face mask, the absorbent material can be in the form of a film or foam, and can be secured to a user-facing, external surface of the face mask. The absorbent material can cover the entire user-facing external layer of the face mask, but it need not do so. In some examples, the absorbent material is a strip of a thin film and is secured to the top of the user-facing, external surface of the face mask. The film can be configured to contact the user's skin, such as the skin proximate the bridge of the user's nose. In some embodiments, the film and the face mask conform to the shape of a user's face.

The absorbent material is capable of absorbing moisture expelled when a person wearing the face mask exhales. The absorbent material traps the exhaled moisture, preventing it from escaping the face mask, where it could condense on and fog eyeglasses of the wearer. While the absorbent material is described as being used in a face mask, persons skilled in the art will understand that the absorbent material could be used in other articles in a similar manner and for a similar purpose. Accordingly, the disclosure of face masks is not intended to exclude other articles that could be combined with the absorbent material. Those skilled in the art will understand how to adapt the disclosure to use the absorbent material with other articles.

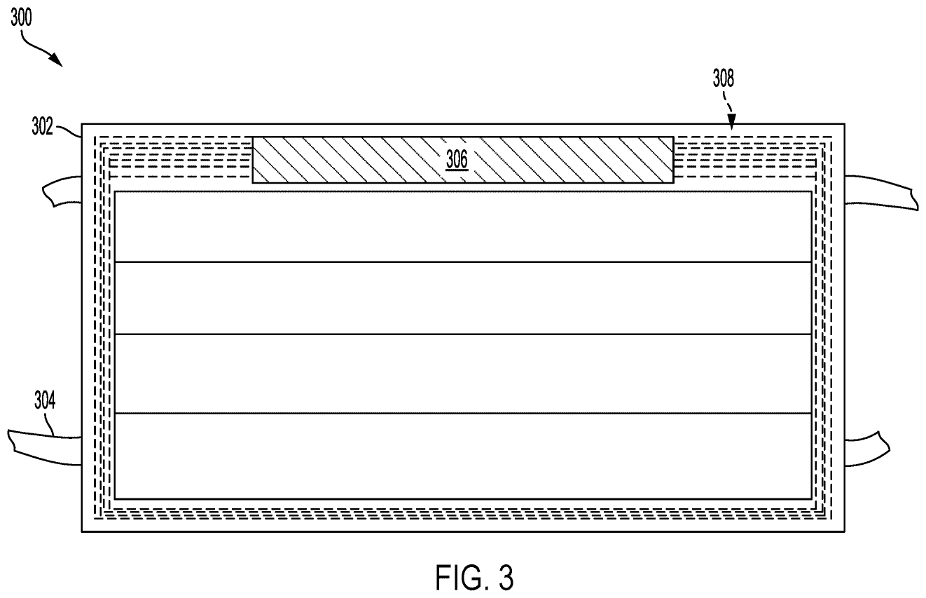

FIG. 3 illustrates a face mask 300 according to one embodiment described herein. The face mask 300 includes a body 302 formed from a filtering material operable to filter hazardous materials from the air a user is breathing. Alternatively, however, the body can be formed of any material useful for a face mask, as determined by one skilled in the art. The body 302 may be configured to conform to a portion of the user's face, such as over the user's mouth and nose. In some embodiments, and as shown in FIG. 3, the face mask 300 includes one or more straps 304 operable to hold the face mask 300 in place on the user's face. In some embodiments, the face mask 300 has a user-facing external surface 308, which is opposite an environment-facing external surface (not shown). The absorbent material 306 is shown as a thin strip at the top of the user-facing external surface 308 of the face mask 300. The absorbent material is positioned to contact the user's skin proximate the bridge of the user's nose. In an alternate embodiment, the absorbent material 306 may be located around the perimeter of the face mask 300 or in any other suitable area, as determined by one skilled in the art. In an alternative embodiment, the absorbent film laminates can be made with the film adhesively or thermally laminated with any non-woven or porous materials. The laminates then can be attached to an article with adhesive or ultrasonic/pressure, or any other bonding methods to make the same.

### EXAMPLES

In the following examples, TPU-1 is aromatic polyester TPU pellets, trade name WHT-F170 (Wanhua Chemical), and TPU-2 is aromatic polyester TPU pellets, trade name Estane® 58238 TPU from Lubrizol Advanced Materials, Inc. Cleveland, OH; the PEO is water-soluble polyethylene oxide powder, trade name Polyox WSR N80 (Dow Chemical); and the SAP is superabsorbent powder, trade name Aqua Keep 10SH-NF (Sumitomo Chemical).

To assess the water absorption properties of films according to embodiments disclosed herein, example films and comparative example films were produced from blends of TPU and PEO, with and without SAM. For each film, the dry film weight was measured and recorded. Then the film was immersed in water or a saline solution (0.9% NaCl) for 30 seconds, 60 seconds, and 180 seconds, and the weight was re-evaluated. Table 1 provides the thin film composition and weights for the films of Examples 1 and 2 and Comparative Example 1.

TABLE 1

| | | Weight (g) | | | | | Immersion |
|---|---|---|---|---|---|---|---|
| | Composition | Dry | 30 s | 60 s | 120 s | 180 s | Liquid |
| Ex. 1 | 20% SAP | 0.284 | 0.771 | 0.937 | | 1.015 | Water |
| | 30% PEO | | | | | | |
| | 50% TPU-1 | | | | | | |
| Ex. 1 | 20% SAP | 0.301 | 0.914 | 1.053 | | 1.07 | Saline |
| | 30% PEO | | | | | | |
| | 50% TPU-1 | | | | | | |
| Ex. 2 | 25% SAP | 0.132 | | 0.44 | | 0.55 | Saline |
| | 35% PEO | | | | | | |
| | 40% TPU-2 | | | | | | |
| Comp. | 60% PEO | 0.106 | 0.235 | 0.290 | 0.215 | | Saline |
| Ex. 1 | 40% TPU-1 | | | | | | |
| Comp. | 60% PEO | 0.237 | 0.642 | 0.640 | | 0.450 | Water |
| Ex. 1 | 40% TPU-1 | | | | | | |

The TPU/PEO-SAP films demonstrated a quick absorption 200% in 30 seconds and reached maximum absorption, up to 320%, in 180 seconds. The film with SAP showed better absorbent behavior, especially in physical appearance. Additionally, the films with SAP can be reused after drying with about 5% weight loss after three immerse-dry cycles. The films without SAP demonstrated weight loss near to 40-50% after immersion for 180 seconds. This is thought to occur due to PEO dissolving into the water. The fast moisture intake is thought to be associated with the increased surface area of from the SAP fine particle size.

By using dynamic vapor sorption (DVS) instrument (e.g. DVS Adventure system from Surface Measurement Systems, LTD), the film composition's dynamic water absorption rate as well as mass change were determined under desired relative humidity, temperature, and exposure time. In a typical experiment, a sample size of 10-20 mg of the said film composition was placed into a DVS Adventure sample pan and then exposed to a dynamic flowing air stream with precisely controlled relative humidity for a desired period of exposure time.

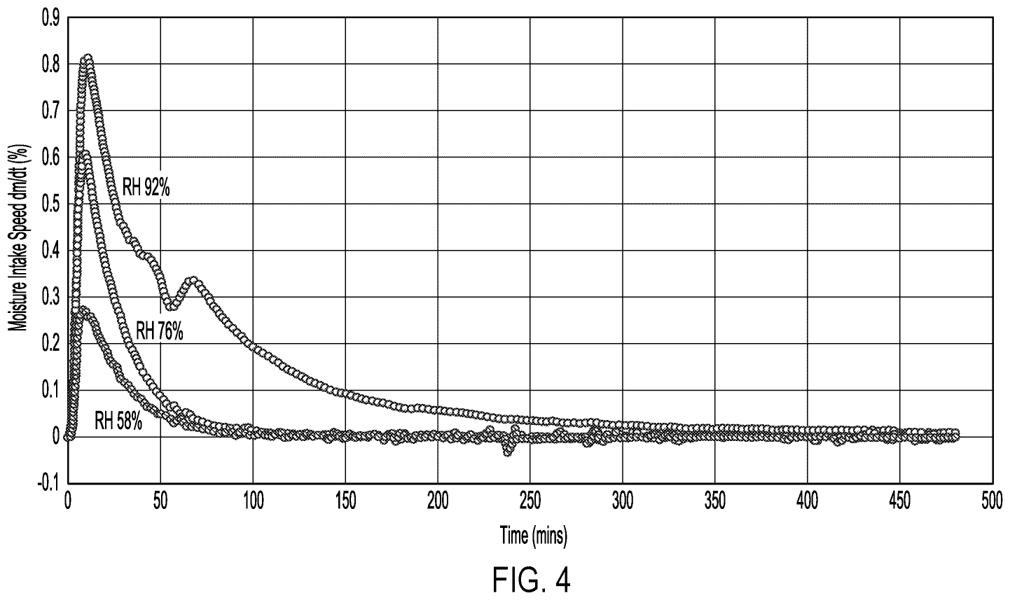

FIG. 4 is a graph of the moisture intake speed of an example thin film composition at different levels of relative humidity. The film composition included 20% by weight of the superabsorbent particles, 30% by weight PEO, and 50% by weight TPU. The film was exposed to different relative humidity conditions while being held at a constant 35° C. The film demonstrated an intake maximum speed (dm/dt) of about 0.28% when exposed to 35% relative humidity, with the speed decreasing to about 0 in the first 100 minutes of exposure. The film composition under 76% relative humidity had a maximum moisture intake speed (dm/dt) of about 0.6 (%) with a decrease in moisture intake to about 0 within the first 100 minutes of exposure. The thin film under 92% relative humidity demonstrated a maximum absorption intake speed (dm/dt) of about 0.80 (%), however the higher relative humidity sample demonstrated a slower decline in intake speed compared to the lower relative humidity exposure conditions. The 92% relative humidity exposure required about 350 minutes before reaching a 0 dm/dt intake speed.

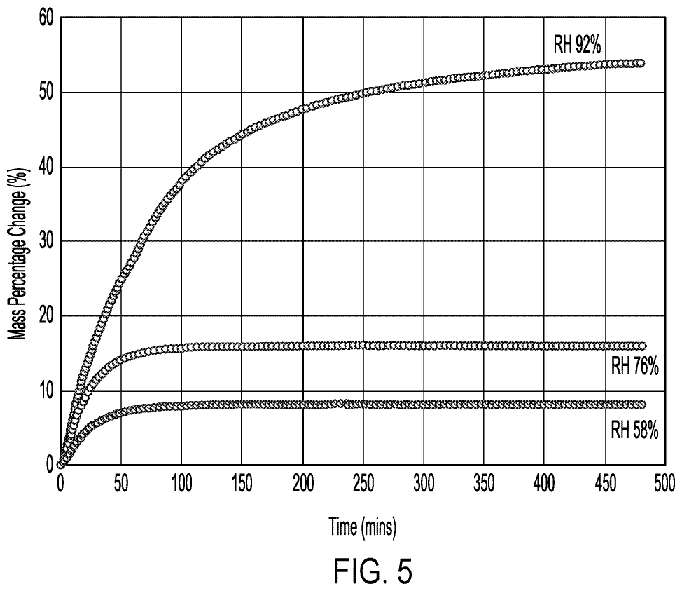

FIG. 5 is a graph of the mass percent change of an example thin film composition at different levels of relative humidity. The film composition included 20% by weight of the SAM, 30% by weight PEO, and 50% by weight TPU. The thin film was exposed to different relative humidity conditions while being held at a constant 35° C. The thin film demonstrated less than 10% mass change when exposed to 35% relative humidity with the increase in mass occurring in the first 50 minutes of exposure. The thin film composition under 76% relative humidity demonstrated about a 17% mass increase also occurring within the first 50 minutes of exposure to the conditions. The thin film composition experienced a mass increase of over 50% when exposed to a relative humidity of 92%. The mass change when exposed to 92% humidity was experienced over 450 minutes with the exponential increase in mass occurring in the first 200 minutes of exposure.

The results demonstrate that the thin film composition absorbs little to no moisture when exposed to low humidity conditions, but experiences high absorption when exposed to high humidity conditions. The results also demonstrate that the thin film has a rapid moisture intake speed and most absorption occurs within the first 50 minutes of exposure. The relative humidity of exhaled air is almost 100%, so when used in combination with a face mask, the superabsorbent-containing film's high moisture absorbing capacity under high relative humidity can quickly remove a high volume of moisture from expelled breath. Thus, the film can provide desired anti-fogging properties by quickly removing moisture from expelled breath before it leaves the face mask.

Though not wishing to be bound by theory, the increased rate of moisture intake and increased absorption capacity of the thin film compared to known products may, in part, be attributed to the high surface area from the super absorbent particle. To address this theory, the super absorbent particles alone were tested using the dynamic vapor sorption (DVS) method. The water absorption rate of the superabsorbent particles was tested in varied relative humidity conditions. In brief, the superabsorbent particles were placed within the instrument, the superabsorbent particles were then exposed to a series of relative humidity changes and the mass was recorded as a function of time. At each humidity change, the sample may first reach gravimetric equilibrium before the next humidity change can occur.

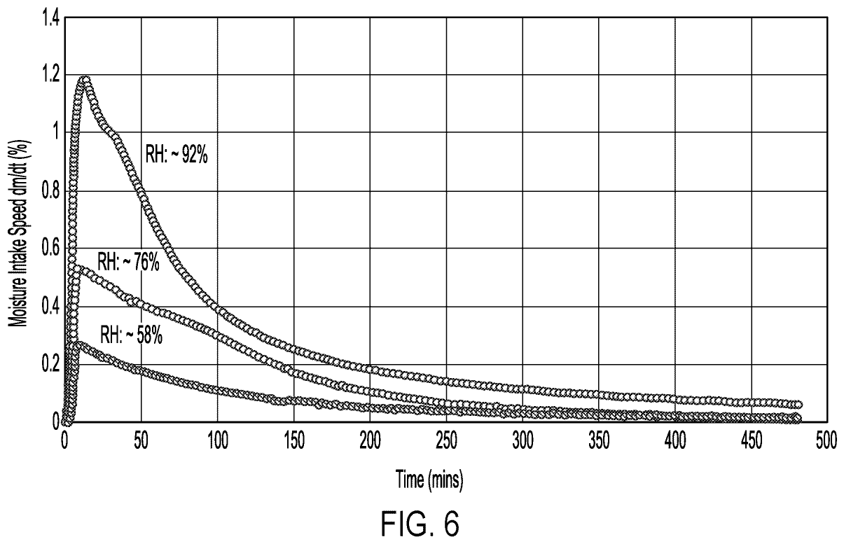

FIG. 6 is a graph of the moisture intake speed of an example superabsorbent particle at different levels of relative humidity. The superabsorbent particles described herein may be around 10 microns to 300 microns. The super absorbent particles used in the experiment shown in FIG. 6 were 20 microns in size. The 20-micron super absorbent particles were exposed to different relative humidity conditions and the weight over time was measured. When the super absorbent particles were exposed to a relative humidity of about 58% the moisture intake speed (dm/dt) was about 0.3 (%) in under 20 minutes with the intake speed decreasing to 0 in about 250 minutes. The superabsorbent particles, when exposed to about 76% relative humidity demonstrated a maximum intake rate (dm/dt) of about 0.5% also within the first 20 minutes with the intake speed decreasing to about 0 within the first 250 minutes. When the super absorbent particles were exposed to about 92% relative humidity the particles demonstrated a maximum intake speed (dm/dt) of about 1.2% within the first 25 minutes. The superabsorbent particles under high humidity conditions, such as the 92% relative humidity, experienced moisture intake through 400 minutes of exposure.

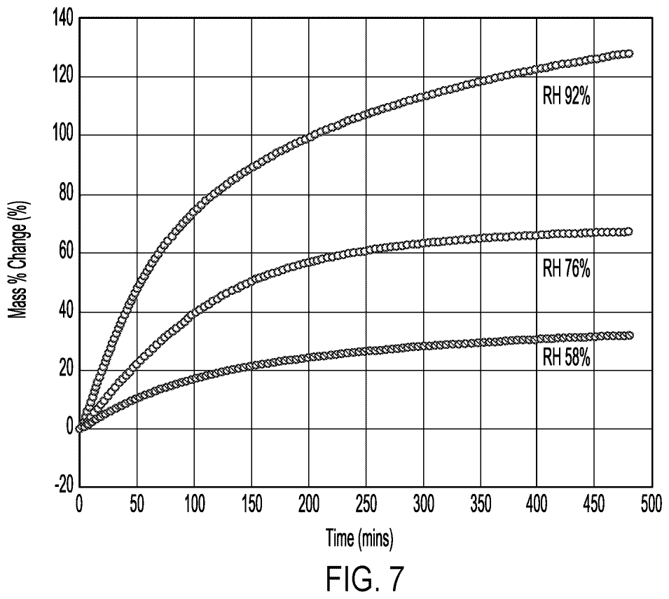

FIG. 7 is a graph of the mass percent change of an example superabsorbent particle at different levels of relative humidity. The superabsorbent particles were exposed to different relative humidity conditions while being held at a constant temperature of 35° C. The superabsorbent particles demonstrated less than a 40% mass change when exposed to 58% relative humidity with the increase in mass occurring in the first 250 minutes of exposure time. The thin film composition exposed to 76% relative humidity demonstrated about a 65% mass increase within the first 450 minutes of exposure. The superabsorbent particles experienced a mass increase of over 1200% when exposed to a relative humidity of 92%. The mass change when exposed to 92% humidity was experienced over 450 minutes with an exponential increase in mass occurring in the first 200 minutes of exposure.

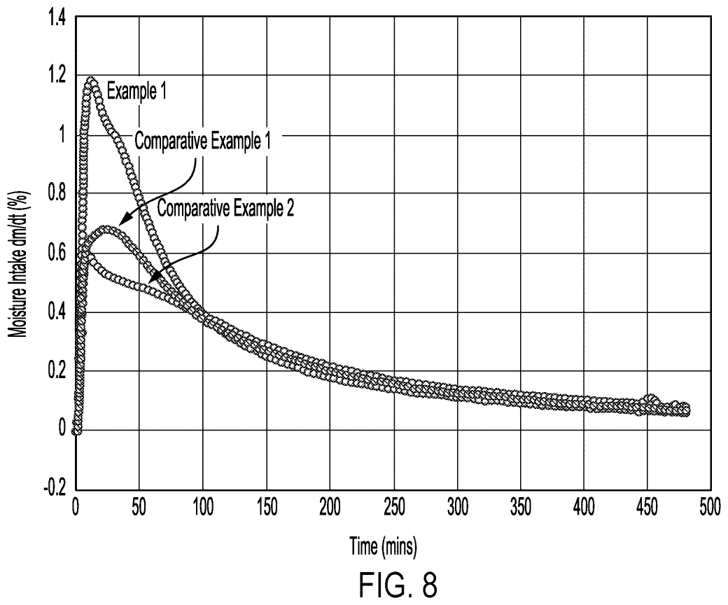

To demonstrate the advantages of the fine superabsorbent particles used in the films according to embodiments described herein, an example of those particles SAP-1 (Aqua Keep 10SH-NF, Sumitomo Seika Chemicals Co., Japan) was compared to two commercial products, SAP-A (Evonik 5630 from Evonik Industries with particle size range of 300-600 microns) and SAP-B (SG200 from SDP Global/Sanyo Chemical, with particle size ranges of 300-600 microns). The moisture intake speeds for SAP-1 (example 1) and SAP-A and SAP-B (comparative examples 1 and 2) were compared as seen in FIG. 8. The SAP-1 particles (example 1) demonstrated a maximum speed intake of about 1.2 within the first 20 minutes while comparative examples 1 and 2 experienced a maximum intake speed of about 0.7 and 0.6,respectively. The SAP-1 particles of example 1 demonstrated a faster intake speed when compared to SAP-A and SAP-B (comparative examples 1 and 2). Though not bound by any theory, it may be that the superabsorbent particles described herein, due to their smaller size, the particles have more surface area to interact with the liquid, thus increasing their absorptive speed as demonstrated. The very fine particles can also be co-extruded with the polymer blend to form a uniform functional moisture management film as described herein.

### Example 2: Absorption Properties of Thin Film Adhered to Face Mask

To test the effectiveness of a film described herein to act as a barrier along the nose of a face mask four films were prepared as 0.75″ by 4.25″ strips and each was adhered to the top, user-facing outer surface of a face mask. A polyolefin-based adhesive was used to secure the films to the face masks. Each face mask was then worn by a user for 1 to 3 hours. Results are shown below in Table 2. Each user was tasked with performing normal daily activity such as office work or walking while wearing the mask. The weight of the film was measured pre- and post-time worn.

TABLE 2
Film with 25% SAP

| Film Weight | After | Time | | Activity | |
|---|---|---|---|---|---|
| before wearing | Wearing | Worn | | Time | User |
| 0.197 (g) | 0.264 (34%) | 3.5 | hours | 45 minutes | A |
| (25% SAP) | | | | walking + 3 | |
| | | | | hours office | |
| 0.274 (g) | 0.332 (21%) | 1.5 | hours | Normal- Walking | A |
| (25% SAP) | | | | | |
| 0.238 (g) | 0.290 (22%) | 1 | hour | Normal-Walking | B |
| (25% SAP) | | | | | |
| 0.198 (g) | 0.230 (16%) | 1.5 | hours | Normal-Office | A |
| (25% SAP) | | | | | |
| 0.328 (g) | 0.362 (10%) | 1 | hour | Normal-Office | C |
| (20% SAP) | | | | | |
| 0.435 (g) | 0.516 (19%) | 3 | hours | Normal-Office | A |
| (20% SAP) | | | | | |

As can be seen from Table 2, after being worn by the user, the films had an increase in weight between 10% and 34%. Eye-glass fogging was reduced, if not eliminated, while the user was wearing the mask with the moisture absorbent film. It should be pointed out as seen in FIGS. 1-5 that the absorptive capabilities of the film may be affected by the relative room humidity as well as the time worn by the user. In some embodiments, the films can incorporate higher percentages of SAP particles, which can allow for an increased absorptive ability of the film. It can also easily be expected that the films with desired sizes/shapes/SAM loadings can be placed at any desired areas within the mask either directly in contact with the skin or built in as an internal layer within the mask structure so direct skin contact can be avoided.

All patents, publications and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the following embodiments:

Embodiment 1: An absorbent material comprising a water-soluble (swellable) polymer, a thermoplastic polyurethane (TPU), and a superabsorbent material.

Embodiment 2: The absorbent material of any preceding or subsequent embodiment, wherein the TPU comprises aromatic groups and ester groups.

Embodiment 3: The absorbent material of any preceding or subsequent embodiment, wherein the water-soluble polymer comprises polyethylene oxide (PEO) comprising a weight average molecular weight (MW) greater than 50,000.

Embodiment 4: The absorbent material of any preceding or subsequent embodiment, wherein the superabsorbent material has an average particle diameter from 10 microns to 100 microns.

Embodiment 5: An article comprising: an absorbent material comprising: a thermoplastic elastomer; a polyethylene oxide (PEO) comprising a weight average molecular weight (Mw) greater than 50,000; and a superabsorbent material.

Embodiment 6: The article of any preceding or subsequent embodiment, wherein the thermoplastic elastomer is a thermoplastic polyurethane (TPU).

Embodiment 7: The article of any preceding or subsequent embodiment, wherein the TPU comprises aromatic groups and ester groups.

Embodiment 8: The article of any preceding or subsequent embodiment, wherein the TPU comprises aromatic isocyanate monomers and polyester polyol monomers.

Embodiment 9: The article of any preceding or subsequent embodiment, wherein the PEO comprises a Mw greater than 150,000.

Embodiment 10: The article of any preceding or subsequent embodiment, wherein the absorbent material is a film.

Embodiment 11: The article of any preceding or subsequent embodiment, wherein the absorbent material is a foam.

Embodiment 12: The article of any preceding or subsequent embodiment, wherein the absorbent material comprises a film or foam non-woven laminate.

Embodiment 13: The article of any preceding or subsequent embodiment, wherein the absorbent article is a face mask.

Embodiment 14: The article of any preceding or subsequent embodiment, wherein the absorbent material is a user-facing external layer of the face mask, and wherein the absorbent material is configured to directly or indirectly contact a user's skin.

Embodiment 15: The article of any preceding or subsequent embodiment, wherein the superabsorbent material has a particle diameter of between 10 and 400 microns.

Embodiment 16: The article of any preceding or subsequent embodiment, wherein the film has a thickness of less than 500 microns.

Embodiment 17: The article of any preceding or subsequent embodiment, wherein the foam has a thickness greater than 300 microns.

Embodiment 18: The article of any preceding or subsequent embodiment, wherein the absorbent material exhibits an increase in absorbent capacity as measured by a dynamic vapor sorption test of at least 100%.

Embodiment 19: The article of any preceding or subsequent embodiment, further comprising a polyolefin-based adhesive for securing the absorbent material to the article.

1. An absorbent material comprising:
a polymer matrix comprising a water-soluble (swellable) polymer, a thermoplastic polyurethane (TPU), and a superabsorbent material, wherein the superabsorbent material is uniformly dispersed in the polymer matrix and has an average particle diameter from 10 microns to 400 microns,
wherein the ratio of TPU to water-soluble polymer ranges from 1:2 to 2:1.

2. The absorbent material of claim 1, wherein the TPU comprises aromatic groups and ester groups.

3. The absorbent material of claim 1, wherein the water-soluble (swellable) polymer comprises a polyethylene oxide (PEO) comprising a weight average molecular weight (Mw) greater than 50,000.

4. (canceled)

5. An article comprising:
an absorbent material comprising:
a polymer matrix comprising:
a thermoplastic elastomer;
a polyethylene oxide (PEO) comprising a weight average molecular weight (Mw) greater than 50,000; and
a superabsorbent material dispersed in the polymer matrix and having an average particle diameter from 10 microns to 400 microns,
wherein the ratio of thermoplastic elastomer to PEO ranges from 1:2 to 2:1.

6. The article of claim 5, wherein the thermoplastic elastomer is a thermoplastic polyurethane (TPU).

7. The article of claim 6, wherein the TPU comprises aromatic groups and ester groups.

8. The article of claim 6, wherein the TPU comprises aromatic isocyanate monomers and polyester polyol monomers.

9. The article of claim 5, wherein the PEO comprises a Mw greater than 150,000.

10. The article of claim 5, wherein the absorbent material is a film.

11. The article of claim 5, wherein the absorbent material is a foam.

12. The article of claim 5, wherein the absorbent material comprises a film or foam non-woven laminate.

13. The article of claim 5, wherein the article is a face mask.

14. The article of claim 13, wherein the absorbent material is a user-facing external layer of the face mask, and wherein the absorbent material is configured to directly or indirectly contact a user's skin.

15. (canceled)

16. The article of claim 10, wherein the film has a thickness of less than 400 microns.

17. The article of claim 11, wherein the foam has a thickness of greater than 300 microns.

18. The article of claim 5, wherein the absorbent material exhibits an increase in absorbent capacity as measured by a dynamic vapor sorption test of at least 100%.

19. The article of claim 5, further comprising a polyolefin-based adhesive for securing the absorbent material to the absorbent article.
